(19) United States
(12) Patent Application Publication
(10) Pub. No.: US 2007/0026720 A1
(43) Pub. Date: Feb. 1, 2007

(54) Floor spring

(75) Inventors: Volker Bienek, Dortmund (DE); Stephan Gosch, Riepsdorf (DE)

Correspondence Address: COHEN, PONTANI, LIEBERMAN & PAVANE, 551 FIFTH AVENUE, SUITE 1210, NEW YORK, NY, 10176, US

(73) Assignee: Dorma GmbH + Co. KG, Ennepetal (DE)

(21) Appl. No.: 10/569,402

(22) PCT Filed: Aug. 10, 2004
(86) PCT No.: PCT/EP04/08920

§ 371 Date: Feb. 22, 2006

(30) Foreign Application Priority Data
Aug. 22, 2003 (DE) 103 39 108.8

(51) Int. Cl. H01R 13/627

(52) U.S. Cl. 439/358

(57) ABSTRACT

A floor-concealed door closer includes a housing for receiving a door closing mechanism, and a housing cover suitable to be mounted on the housing. The housing cover has a receiving groove on its inside surface facing the housing for receiving a seal. In order to mount the housing cover on the housing with fewer screws than in previous models while maintaining the impermeability between the housing and the housing cover, the depth of the receiving groove varies over its length.

### SPECIFICATION

The invention relates to a floor-concealed door closer with a housing for holding a closing mechanism, where the housing is covered by a housing cover, which supports the closing mechanism's axle, which carries a door or the like.

Floor-concealed door closers of this type are known from, for example, DE 295 01 929.8 U1. They have a housing, in which the actual closing mechanism of the door closer is installed. An axle extends out from the housing. This axle supports the door or the like to be actuated. The housing can be closed by a housing cover, which supports the axle and which can be connected to the housing preferably by screws.

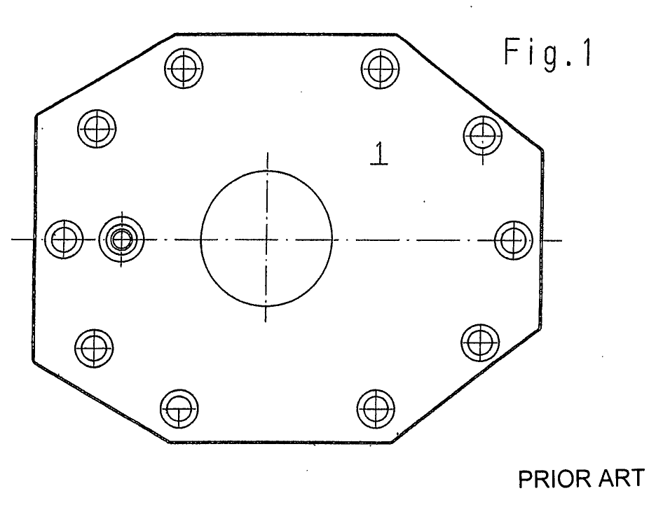

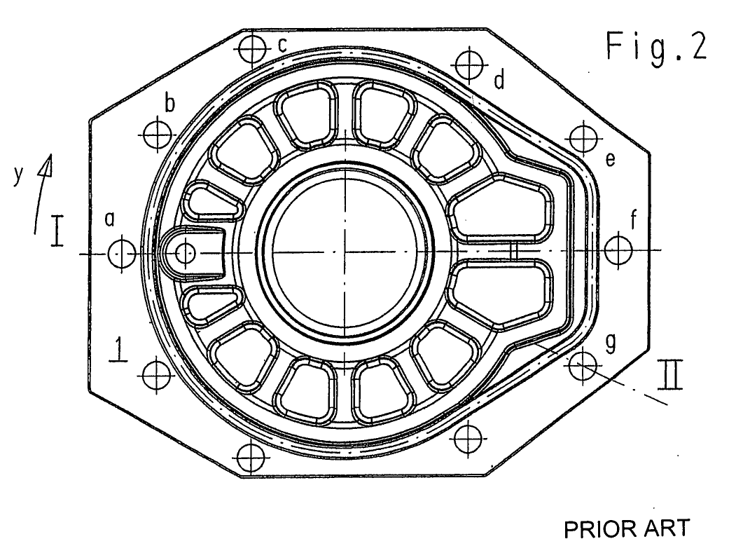

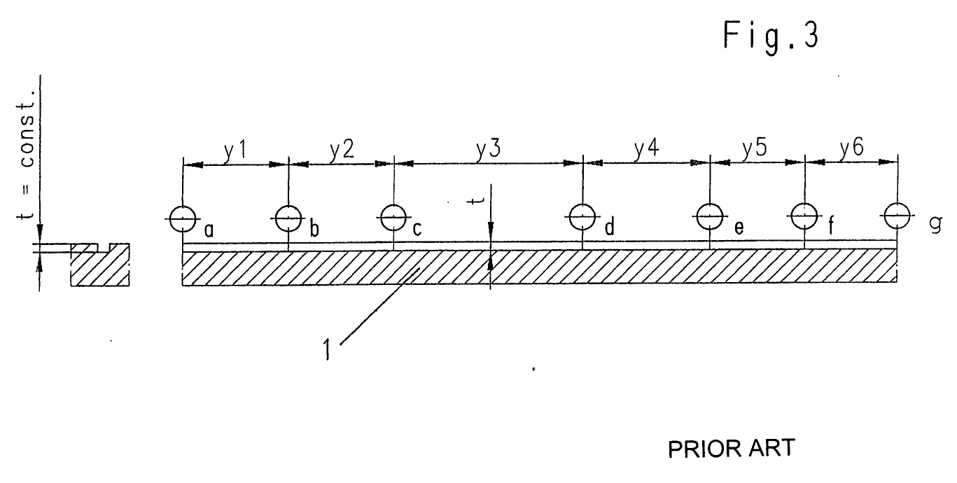

A housing cover of this type is illustrated by way of example in FIGS. 1-3, which show views from above, from below, and in cross section. A receiving groove of constant depth “t” is machined into the housing cover 1. A seal can be inserted into this groove to seal the housing cover to the housing. The screw holes through which the screws pass are designated a-g (see FIG. 2), and the spaces between the individual screw holes a-g are designated y1-y6 (see FIG. 3).

A general requirement on the design of floor-concealed door closers is that it must be possible to mount the housing as easily and as quickly as possible. To satisfy this requirement, the number of screws by which the housing cover is screwed to the housing should be as small as possible, so that the installation process as well as later maintenance and repair work will take as little time as possible.

It is not possible, however, to reduce the number of screws without taking additional measures to compensate. In the case of conventional housing covers, tightening the screws has the effect of exerting pressure on the seal which has been inserted into the receiving groove. If the number of screws is simply reduced, some of this pressure on the seal is lost, and leaks can occur.

The task of the present invention is therefore to create a floor-concealed door closer in which the housing cover can be attached with fewer screws than before and which nevertheless guarantees that the seal between the housing and housing cover remains intact.

This task is accomplished for a floor-concealed door closer of the type explained above in that the depth of the receiving groove varies over its length.

As a result of this design, when the screws are tightened, the pressure produced in the areas where the receiving groove is shallower is greater than that in the areas where the receiving groove is deeper. This makes it possible to increase the space between the screws, so that some of the individual screws can be eliminated.

The subclaims present additional embodiments of the inventive object.

According to a preferred elaboration, the receiving groove has areas of greater depth and areas of lesser depth. Through the use of a receiving groove of this type with areas of different depths, the pressure exerted on the seal can be varied as a function of the spacing between the screws and thus adapted to the concrete circumstances.

The individual areas preferably merge continuously with each other so that no discontinuities are present in the depth of the receiving groove and thus no notch effects can occur in the seal.

The greater spacing between the individual screws made possible by the inventive design leads to greater stress on the housing cover, which can cause it to deform. To counteract this, the housing cover is provided, according to a preferred elaboration, with a stiffening shoulder in at least one edge area. As a result of this design, it is possible to give the housing cover a greater section modulus against flexure, so that the deformations which might be caused by the increased pressure can be resisted.

An especially low-distortion design of the housing cover can be obtained in accordance with a preferred embodiment by providing a stiffening shoulder on the end surface and additional stiffening shoulders on the transverse sides.

The inventive object is explained in greater detail on the basis of an exemplary embodiment illustrated in the drawings:

FIG. 1 shows a view from above of a housing cover according to the state of the art;

FIG. 2 shows a view from below of the housing cover according to FIG. 1;

FIG. 3 shows a cross section through the housing cover according to FIG. 1 along line I-II;

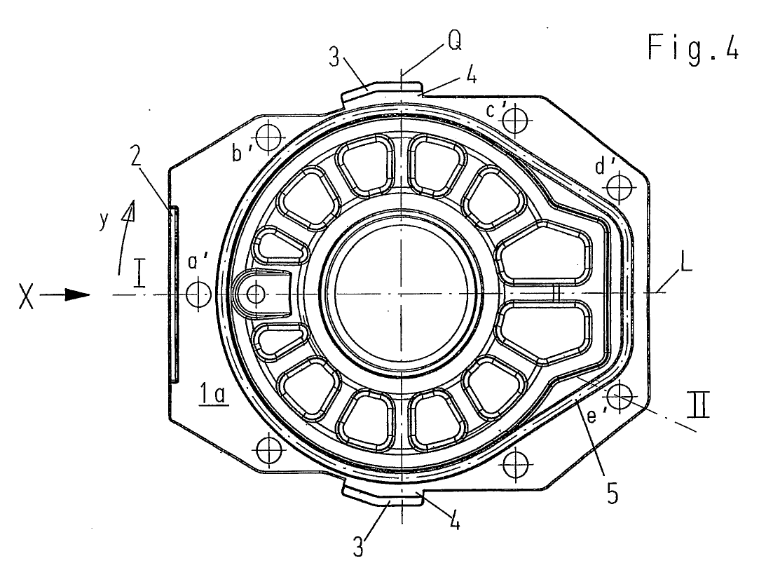

FIG. 4 shows a view from above of a housing cover according to the invention;

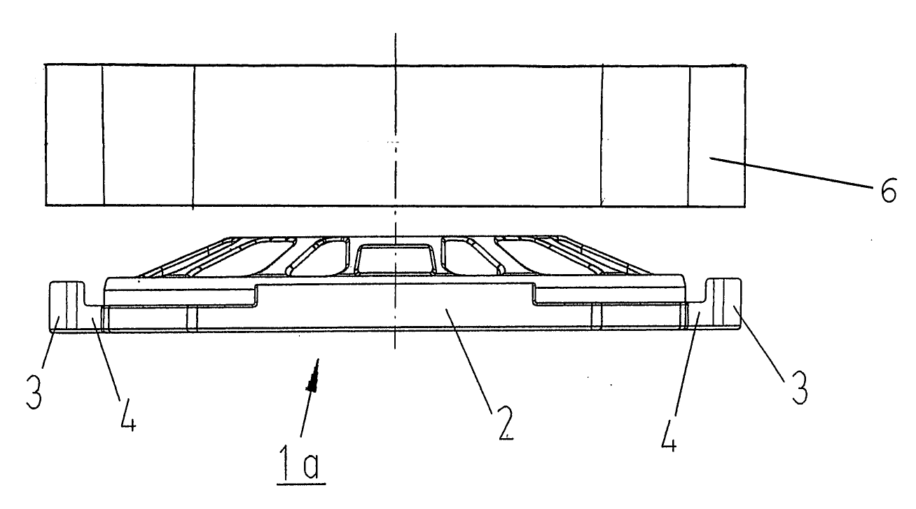

FIG. 5 shows a view of the inventive housing cover looking in the direction of arrow X in FIG. 4;

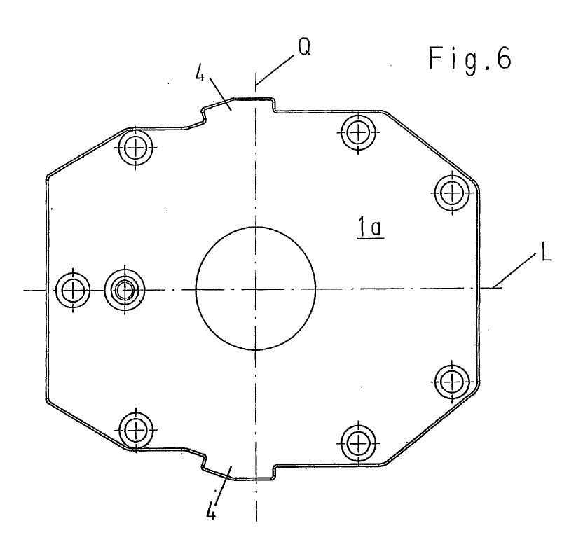

FIG. 6 shows the inventive housing cover from above; and

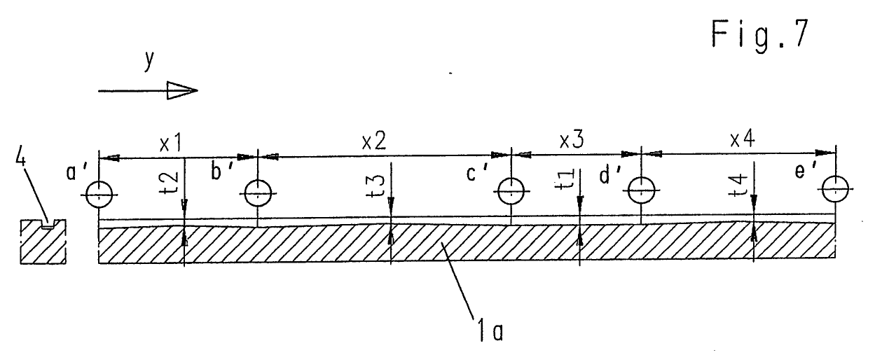

FIG. 7 shows a cross section through the housing cover along line I-II in FIG. 4.

Only the housing cover of interest is shown in the figures; the rest of the floor-concealed door closer is omitted.

FIG. 4 shows a view of the inventive housing cover 1a from below. The same housing cover la is shown from above in FIG. 6 and in FIG. 5 in a view looking in the direction of the arrow X in FIG. 4. FIG. 7 shows a cross section through the inventive housing cover 1a along line I-II in FIG. 4.

On the side of the housing cover 1a which faces down when the cover is installed, a receiving groove 5 is provided, into which a seal (not shown) of uniform thickness can be inserted; this seal can be a section of a hose cut to the desired length, for example.

As is especially clear in FIG. 7, the depth t1-t4 of the receiving groove 5 varies from area to area along the line I-II, so that the receiving groove 5 has areas of greater depth and areas of lesser depth t1-t4, which merge with each other in continuously rising or falling fashion. Thus, for example, the depth of the receiving groove 5 between screw hole a′ and screw hole b′ decreases to a depth t2, and between the screw holes b′ and c′ it decreases to a depth of t3, whereas the depth t1 between the screw holes c′ and d′ remains constant. Between the screw holes d′ and e′, the depth of the receiving groove 5 again decreases to a depth t4. Overall, the depth of the receiving groove 5 reaches a maximum in the areas directly at the screw holes a′-e′, whereas it reaches a minimum in the intermediate areas between the screw holes a′-e′.

As can be seen especially clearly from a comparison of FIGS. 3 and 7, the distances y1-y6 between the screw holes a-g in the case of housing cover 1 according to the state of the art are shorter than the distances x1-x4 between the screw holes a′-e′ of the inventive housing cover 1a. This has the result that, in the case of the housing cover 1 according to the state of the art, seven screw holes a-g are provided along the Line I-II, whereas, in the case of the housing cover 1a designed according to the invention, only five screw holes a′-e′ are provided along the line I-II. Thus, as a result of the inventive design, two screw holes car be eliminated over a section of the same length.

This can also be seen from a comparison of FIGS. 2 and 4, where, as a result of the inventive design, the screw hole f located all the way to the right in FIG. 2 in the housing cover 1 according to the state of the art has been eliminated from the housing cover 1a according to FIG. 4.

So that the longer distances between the screw holes a′-e′ cannot lead to undesirable deformations of the housing cover 1a, stiffening shoulders 2, 3 are provided, which project from the bottom surface of the housing cover 1a.

One of the stiffening shoulders 2, 3, namely, the stiffening shoulder 2, is flush with an end surface of the housing cover 1a and is centered on a longitudinal center axis L of the housing cover 1a. It is straight and extends essentially at a right angle to the center longitudinal axis L.

The two other stiffening shoulders 3 are provided on the transverse sides of the housing cover 1a. They are intersected by a transverse center axis Q of the housing cover 1a and, instead of being straight like the stiffening shoulder 2, they have an inflection.

Instead of the inflection shown here, the stiffening shoulders 3 could also be curved, for example.

The stiffening shoulders 3 provided on the transverse sides of the housing cover 1a are formed on projections 4, which extend outward in the plane of the housing cover 1a in the direction of the transverse center axis Q. The stiffening shoulders 3 are flush in this case with the outer edge of the projections.

List of Reference Numbers
1 housing cover according to the state of the art
1a housing cover according to the invention
2 stiffening shoulder
3 stiffening shoulder
4 projection
5 receiving groove
L longitudinal center axis
Q transverse center axis
a-g screw holes according to the state of the art
a′-e′ screw holes according to the invention
t depth of the receiving groove according to the state of the art
t1-t4 depth of the receiving groove according to the invention
y1-y6 center-to-center distances of the individual screw holes according to the state of the art
x1-x4 center-to-center distances of the individual screw holes according to the invention

1.-14. (canceled)

15. A floor-concealed door closer comprising:
a housing for receiving a door closing mechanism; and
a housing cover for mounting on the housing, the housing cover having an inside surface facing the housing and a receiving groove on the inside surface for receiving a seal, the receiving groove having a length and a depth which varies over the length.

16. The door closer of claim 15, wherein the receiving groove has a plurality of areas with a first depth and a plurality of areas with lesser depths than the first depth.

17. The door closer of claim 16, wherein the areas merge continuously with each other.

18. The door closer of claim 17, wherein the housing cover further comprises a plurality of screw holes along the length of the receiving groove, and intermediate areas between the screw holes, the areas with a first depth being adjacent to the screw holes, the areas with lesser depths being adjacent to the intermediate areas.

19. The door closer of claim 15, wherein the housing cover is operable to support an axle of the closing mechanism and further has an edge area and a stiffening flange in the edge area.

20. The door closer of claim 19, wherein the housing cover further has an end surface, the stiffening flange being flush with the end surface.

21. The door closer of claim 19, wherein the housing cover further has a longitudinal center axis, the stiffening flange being centered on the longitudinal center axis.

22. The door closer of claim 21, wherein the edge area of the housing cover comprises two opposite side edges generally parallel to the longitudinal center axis, the housing cover further comprising a stiffening flange on each of the side edges.

23. The door closer of claim 22, wherein the housing cover further has a transverse center axis passing through the second stiffening flanges on the side edges.

24. The door closer of claim 22, wherein the housing cover further has two lateral projections, the flanges on the side edges being on respective said projections.

25. The door closer of claim 24, wherein the projections have a length and the stiffening flanges on the projections have the same length as the projections.

26. The door closer of claim 20, wherein the stiffening flange on the end surface is straight.

27. The door closer of claim 22, wherein the stiffening flange on each said lateral projection is inflected.

28. The door closer of claim 22, wherein the stiffening flange on each said lateral projection is curved.

29. The door closer of claim 22, wherein each said stiffening flange projects into the housing when the housing cover is mounted on the housing.
